(19) United States
(12) Patent Application Publication
(10) Pub. No.: US 2026/0115731 A1
(43) Pub. Date: Apr. 30, 2026

(54) SYSTEM FOR RETAINING BEARING ASSEMBLIES OF A COMPACT ECCENTRIC CRUSHER

(71) Applicant: METSO USA INC., Brookfield, WI (US)

(72) Inventors: Guido Leuschen, Bielefeld (DE); Leon Bei der Sandwisch, Neuenkirchen (DE)

(73) Assignee: METSO USA INC., Brookfield, WI (US)

(21) Appl. No.: 18/932,751

(22) Filed: Oct. 31, 2024

(51) Int. Cl. B02C 2/08; F16C 35/067

(52) U.S. Cl. CPC B02C 2/08; F16C 35/067; F16C 2320/23

(57) ABSTRACT

A compact eccentric crusher that includes a system for releasing and retaining the bearing assembly of the crushing roller. The compact eccentric crusher includes a crushing roller supported by a drive shaft. The drive shaft is rotatably supported by a pair of bearing assemblies located on the opposite ends of the drive shaft. The outer housing of each bearing assembly is removably supported in a bearing cradle formed as part of a bearing support structure. A locking assembly is included to hold the bearing assemblies in the bearing cradles to prevent axial and vertical movement of the bearing housings. Each locking assembly includes a locking wedge and a clamping wedge that can be used to clamp the bearing housing in place. The locking wedge can be removed to allow the crushing roller assembly to be lifted out of the compact eccentric crusher.

### BACKGROUND

The present disclosure generally relates to a system for releasing and retaining the bearing assembly of a compact eccentric crusher that has a stationary crushing member and a moving crushing roller. More specifically, the present disclosure relates to a system that increases the ease of removal and retention of the bearing assembly on each side of the crushing roller.

Presently, different types of crushers are being used to reduce the size of mineral material present in an infeed to the crusher. After processing, the size of the mineral material has been reduced to create a supply of the mineral material having smaller sized individual components. In these types of crushers, a moving crushing member moves toward and away from a stationary crushing member to create a varying crushing gap to crush the mineral material of the infeed.

One type of crusher used to reduce the size of mineral material is referred to as a compact eccentric crusher. In a compact eccentric crusher, a freely rotatable crushing roller is mounted to an eccentric shaft by a series of roller bearings. The crushing roller is spaced from a generally stationary crusher jaw. In the compact eccentric crusher, the eccentric arrangement of the crushing roller on the eccentric drive shaft creates eccentric movement of the crushing roller toward and away from the stationary crusher jaw. This eccentric movement varies the size of the crushing gap, which causing the mineral material fed into the compact eccentric crusher to be crushed in the crushing gap.

During operation, the freely rotatable mounting of the crushing roller on the eccentric drive shaft results in a slow rotation of the crushing roller about the eccentric drive shaft in a direction opposite to the rotation of the eccentric drive shaft. Although the crushing force is created by the lateral movement of the crushing roller relative to the stationary crusher jaw, the free rotation of the crushing roller about the drive shaft during the eccentric movement distributes wear to all portions of the outer circumference of the crushing roller.

After extended use of the compact eccentric crusher, wear elements that define the crushing surface of the crushing roller need to be removed and replaced. Since the interior of the compact eccentric crusher is difficult to access, it is desirable to be able to lift the entire crushing roller assembly out of the crusher for maintenance. Presently, the removal of the entire crushing roller assembly requires the removal of a significant amount of the crusher assembly, making maintenance both time consuming and labor intensive.

The inventors of the present disclosure have recognized a need for an improvement in the ability to initially install the crushing roller assembly and later the removal of the crushing roller assembly for maintenance. The inventors have developed a configuration of a bearing cradle and locking assembly that securely receives and retains the crushing roller assembly while also allowing for the release and removal of the crushing roller assembly from above.

### SUMMARY

The present disclosure generally relates to a system for releasing and retaining the bearing assembly of a compact eccentric crusher that has a stationary crushing member and a moving crushing roller. More specifically, the present disclosure relates to a system that increases the ease of removal and retention of the bearing assembly on each side of the crushing roller.

According to one exemplary embodiment of the present disclosure, a crusher is provided that is operable to crush a supply of mineral material. The crusher includes a crusher frame that has a pair of spaced side walls and an end wall that at least partially defines a crushing chamber that receives the mineral material being crusher. The crusher includes a stationary crushing member that is stationary during the crushing operation. In an exemplary embodiment, the stationary crushing member is a crusher jaw. The crusher further includes a crushing roller that is spaced from the stationary crushing member to define a crushing gap. During operation, the crushing roller is movable toward and away from the stationary crushing member to change the crushing gap and crush mineral material in the crushing gap.

The crusher further includes a drive shaft that supports the crushing roller. The drive shaft is supported at each of its first and second ends by a bearing assembly. The bearing assembly allows for rotation of the drive shaft. Each of the bearing assemblies is received in a bearing support structure that is located adjacent to one of the side walls of the crusher frame.

The bearing support structure includes a bearing cradle that is located and sized to receive one of the bearing assemblies that support the ends of the drive shaft.

When the bearing assemblies are received in the bearing cradles of the bearing support structures, a locking assembly is positioned between the bearing support structure and the bearing assembly to hold the bearing assembly in an installed position. The locking assembly restricts both the vertical and axial movement of the bearing assembly during operation of the crusher. When the locking assemblies are removed, the crushing roller assembly, including the drive shaft, crushing roller and the bearing assemblies can be lifted from the frame and moved to a removed position.

In one exemplary embodiment of the present disclosure, the bearing cradles of each of the bearing support structures have open upper ends that allow the bearing assemblies to be vertically inserted and removed from the bearing cradles. The locking assembly used on each side of the crusher includes a clamping wedge mounted to a front wall of the bearing cradle and a locking wedge that is positioned between a back wall of the bearing cradle and the bearing assembly. In one exemplary embodiment, the locking wedge engages both the bearing cradle and an outer housing of the bearing assembly. When the locking wedge is installed, the downward movement of the locking wedge causes the outer housing of the bearing assembly to move both downward and rearward to hold the outer housing in place in the bearing cradle.

In another exemplary embodiment of the present disclosure, the bearing assembly includes an eccentric bearing in the outer housing. The rotation of the drive shaft within the eccentric bearing creates eccentric movement of the crushing roller relative to the stationary crusher jaw.

In another exemplary embodiment of the present disclosure, a compact eccentric crusher is disclosed that includes a crusher jaw and a crushing roller that is spaced from the crushing jaw to define a crushing gap. During operation of the compact eccentric crusher, the crushing roller is movable toward and away from the crusher jaw to change the size of the crushing gap and crush the mineral material fed into the crusher. The crushing roller is supported on a drive shaft, which in turn is rotatable at each of the first and second ends by a bearing assembly. Each bearing assembly includes a outer housing. The rotation of the drive shaft in eccentric bearings creates eccentric movement of the crushing roller.

The compact eccentric crusher further includes a crusher frame that includes a pair of spaced side walls and an end wall that define a crushing chamber. A pair of bearing support structures are positioned on each side of the frame adjacent to the side walls of the frame. The bearing support structures each include a bearing cradle that is sized and positioned to receive one of the bearing assemblies. When the bearing assemblies are received in the bearing cradles, a locking assembly is positioned between the bearing support structure and the outer housing of the bearing assembly to retain the bearing assembly in an installed position. The locking assembly is designed and configured to restrict the vertical and axial movement of the outer housing of the bearing assembly. The locking assembly is designed to be removable such that the bearing assembly can be removed from the bearing cradle when the locking assembly is removed.

In one exemplary embodiment, the bearing cradles and the side walls of the frame of the compact eccentric crusher are designed such that the bearing assemblies can be vertically removed or installed into the bearing cradles. The side walls of the frame are designed to include a receiving channel that is aligned with the bearing cradle to allow the vertical movement of the bearing assemblies into and out of the bearing cradles.

The locking assemblies of the exemplary embodiment of the compact eccentric crusher include a clamping wedge that is mounted to a front wall of the bearing cradle and a locking wedge that is received between the outer housing of the bearing assembly and the back wall of the bearing cradle. The locking wedge and the clamping wedge are each designed to restrict the axial movement of the outer housing of the bearing assembly. In one contemplated embodiment, the locking wedge and clamping wedge include either a locking ridge or a locking channel that engages a corresponding locking channel or locking ridge on a portion of the outer housing. The engagement between the locking channels and locking ridges restricts the axial movement of the outer housing. When the locking wedge is installed, a vertical downward force is applied to the locking wedge. Such force and movement create a holding force that is directed to the interface between the outer housing and the clamping wedge. The holding force holds the outer housing in place along the clamping wedge.

In accordance with the present disclosure, a method of removably mounting a crusher roller assembly into a compact eccentric crusher is provided. The compact eccentric crusher includes a frame, and a pair of bearing support structures positioned adjacent to the side walls of the frame, and each includes a bearing cradle. According to the method, the crushing roller assembly is lowered until the outer housing of the crushing roller assembly is received in one of the bearing cradles. Once the outer housing is supported, a locking wedge is positioned between a locking surface on the outer housing and the bearing cradle. In this position, a locking force is exerted on the locking wedge to force the outer housing into contact with a clamping wedge that is positioned in the bearing cradle. The locking wedge is then retained in this position such that the locking assembly, including the locking wedge and the clamping wedge, restricts the axial and vertical movement of the outer housing of the bearing assembly.

According to the method of the present disclosure, when the crushing roller assembly needs to be removed from the compact eccentric crusher, the locking force on the locking wedge is removed. The removal of the locking force allows the locking wedge to be removed. With the locking wedge removed, the entire crushing roller assembly can be removed from the bearing cradles. The side walls of the frame are designed to include a receiving channel that is aligned with the bearing cradles to allow vertical movement of the bearing assemblies into and out of contact with the bearing cradles.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a side view showing the general operation of a compact eccentric crusher that includes a stationary crusher jaw and a movable crushing roller;

FIG. 2 is a perspective view of a compact eccentric crusher including the subject matter of the present disclosure;

FIG. 3 is a section view of the compact eccentric crusher showing the crusher jaw and crushing roller;

FIG. 4 is an exploded view of the compact eccentric crusher;

FIG. 5 is a perspective view of the compact eccentric crusher with components removed to show the support of the crushing roller assembly by the bearing support structure;

FIG. 6 is an explode view of select components illustrating the locking assembly and the bearing housings;

FIG. 7 is a magnified top view illustrating the locking assembly holding the outer housing of the bearing assembly in the bearing cradle;

FIG. 8 is a side view showing the removal of the crushing roller assembly;

FIG. 9 is a side view showing the insertion of the crushing roller assembly into the compact eccentric crusher frame and bearing support assembly.

### DETAILED DESCRIPTION

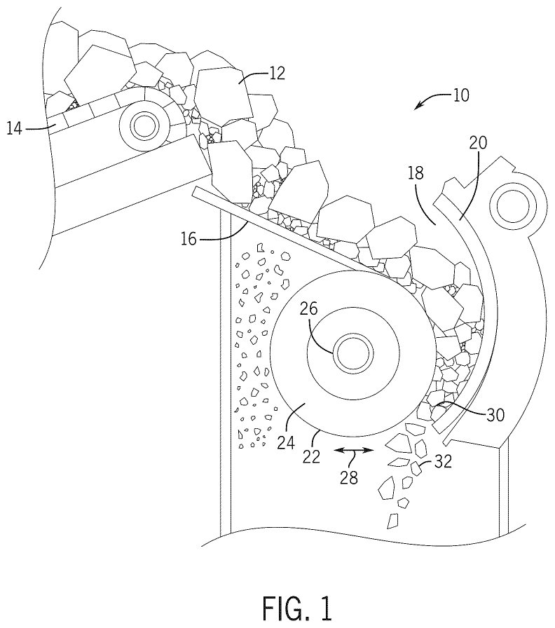

FIG. 1 generally illustrates the operation of a compact eccentric crusher 10. The compact eccentric crusher 10 shown in FIG. 1 is a representative embodiment that is included to show the general operation and configuration of a compact eccentric crusher 10 and does not limit the scope of the present disclosure since it is being included for illustrative purposes. As illustrated in FIG. 1, the compact eccentric crusher 10 receives a supply of mineral material 12 from an infeed conveyor 14. In the embodiment shown, the supply of mineral material 12 may include particles of different sizes that all fall upon an infeed screen 16 that includes slots or other openings that allow particles of a small enough size to bypass the primary crushing operation. The infeed screen 16 directs the larger particles of the supply of mineral material into a crushing chamber 18. In other contemplated embodiments, the infeed screen 16 could be eliminated such that the entire supply of material would be directed to the crushing chamber 18.

The crushing chamber 18 is generally formed between the stationary jaw 20 and the outer surface 22 of the crushing roller 24. As will be described in greater detail below, the crushing roller 24 is mounted to a drive shaft 26 that is supported by an eccentric bearing assembly that creates eccentric movement of the outer surface 22 of the crushing roller 24 along an eccentric path that includes movement toward and away from the stationary jaw 20, as schematically illustrated by arrow 28. The eccentric movement of the entire crushing roller 24 increases and decreases the size of the crushing gap 30. The increase and decrease in the size of the crushing gap 30 crushes the larger particles of the infeed stream to result in an outlet product flow 32.

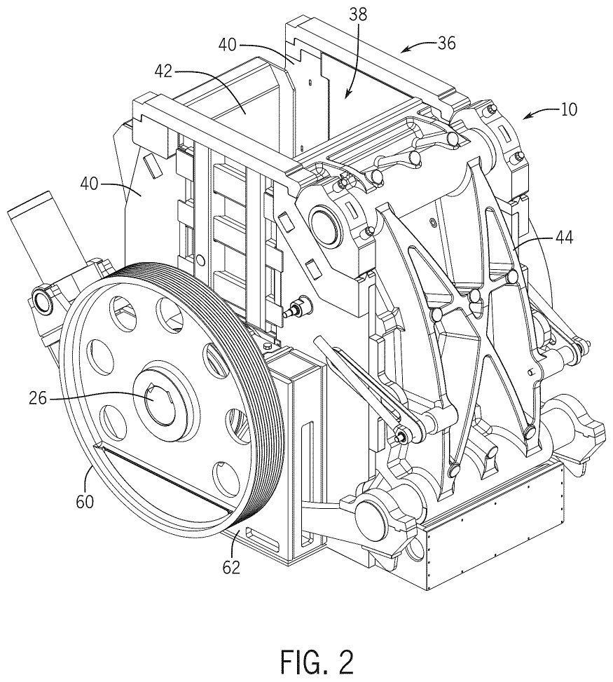

Referring now to FIG. 2, the compact eccentric crusher 10 constructed in accordance with the present disclosure will now be further described. In the embodiment shown in FIG. 2, the compact eccentric crusher 10 is shown as including a frame 36 that is designed to support the eccentric movement of the crusher roller and to receive a product flow at an open upper end 38 that feeds into an internal crushing chamber 18, as was schematically illustrated in FIG. 1. The frame 36 includes a pair of side walls 40 that are each spaced from each other to define a portion of the crushing chamber. A rear wall 42 further defines the crushing chamber while the jaw assembly 44 defines the front portion of the crushing chamber.

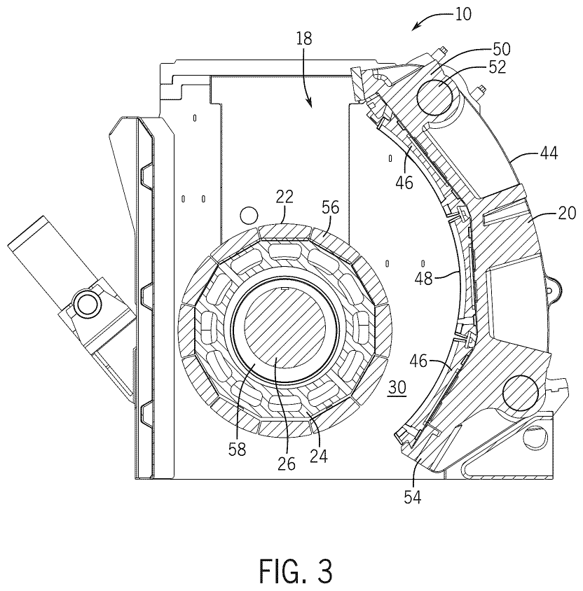

The jaw assembly 44 includes the crusher jaw 20 that includes a series of wear plates 46 as best shown in FIG. 3. The wear plates 46 define a contact surface 48 for the crusher jaw 20 that is spaced from the outer surface 22 of the crushing roller 24. The spacing between the outer surface 22 of the crushing roller 24 and the contact surface 48 of the wear plates 46 creates the crushing gap 30 used to crush the mineral material fed into crushing chamber 18 of the compact eccentric crusher 10. In the embodiment shown in FIG. 3, an upper end 50 of the crushing jaw 20 is mounted for rotational movement about a pivot point 52. The lower end 54 of the crushing jaw 20 can be moved inward and outward to adjust the size of the crushing gap 30. As indicated previously, during operation of the compact eccentric crusher 10, the crusher jaw 20 is maintained in a stationary position while the crushing roller 24 moves along an eccentric path to increase and decrease the size of the crushing gap 30 to crush the mineral material.

The crushing roller 24 includes a series of wear members 56 installed on the crushing roller 24 to define the outer surface 22. During operation of the compact eccentric crusher 10, the outer surface 22 contacts the mineral material being crushed and is thus subject to wear. The individual wear members 56 can be removed from the crushing roller 24 upon sufficient wear. The crushing roller 24 is mounted to the drive shaft 26 by a series of roller bearings such that the crushing roller 24 can freely rotate relative to the drive shaft 26. As discussed previously, during normal operation, the crushing roller 24 may not rotate or may rotate in the opposite direct as the rotation of the drive shaft 26. The drive shaft 26 is rotatable by a drive motor or motors during operation of the compact eccentric crusher 10.

As illustrated in the section view of FIG. 3, an eccentric bearing 58 is located between the crushing roller 24 and the drive shaft 26. In this manner, rotation of the drive shaft 26 creates eccentric movement of the entire crushing roller 24, thus causing the lateral movement of the crushing roller 24 toward and away from the crusher jaw 20. Such eccentric movement increases and decreases the size of the crushing gap 30 to crush the mineral material in the crushing gap 30.

Referring back to FIG. 2, the compact eccentric crusher 10 further includes a fly wheel 60 mounted to either side of the drive shaft 26. The fly wheel 60 provides rotational mass that combines with the mass of the crushing roller during operation of the compact eccentric crusher 10. The fly wheels 60 are mounted axially outward from a bearing support structure 62 located on each side of the compact eccentric crusher 10. The bearing support structures 62 provide support for one of a pair of bearing assemblies that are used to support and create the eccentric movement of the crushing roller within the open crushing chamber 18 defined by the frame.

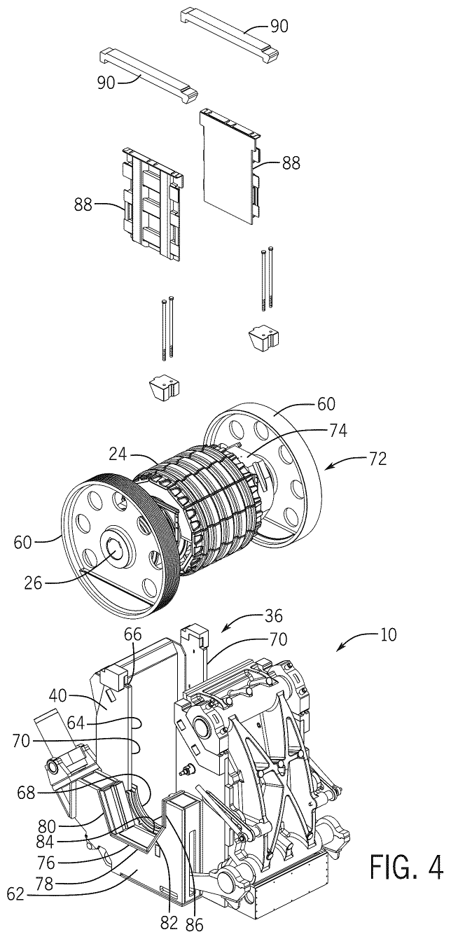

FIG. 4 is an exploded view of the compact eccentric crusher 10 of the present disclosure. As shown in the exploded view of FIG. 4, each of the side walls 40 of the frame 36 includes a receiving channel 64 that extends from the top end 66 of the frame 36 to a bottom end 68. The bottom end 68 of the receiving channel is configured to receive a portion of the bearing assembly 74 that rotatably supports the drive shaft 26. The receiving channel 64 is defined by a pair of vertical side edges 70 that are spaced from each other such that the receiving channel 64 has a constant width from the bottom end 68 to the top end 66. In this manner, the crushing roller assembly 72, which includes the crushing roller 24, the pair of fly wheels 60, the drive shaft 26 and the pair of bearing assemblies 74 can be lowered and raised in a vertical direction into and out of the frame 36.

As shown in FIG. 4, the bearing support structure 62 is positioned adjacent to the side wall 40 and includes a bearing cradle 76 that is sized to receive one of the bearing assemblies 74 included as part of the crushing roller assembly 72. The bearing cradle 76 is upwardly open and aligned with one of the receiving channels 64. The bearing cradle 76 is generally defined by a horizontal bottom wall 78, an upwardly and outwardly sloping front wall 80 and a back wall 82. The back wall 82 includes both a sloping portion 84 and a vertical portion 86. As will be described in greater detail below, the specific configuration of the bearing cradle 76 is designed to receive and retain one of the bearing assemblies 74 to restrict both the axial and vertical movement of the bearing assembly 74 when the crushing roll assembly 72 is received within the frame 36 and the associated bearing support structure 62.

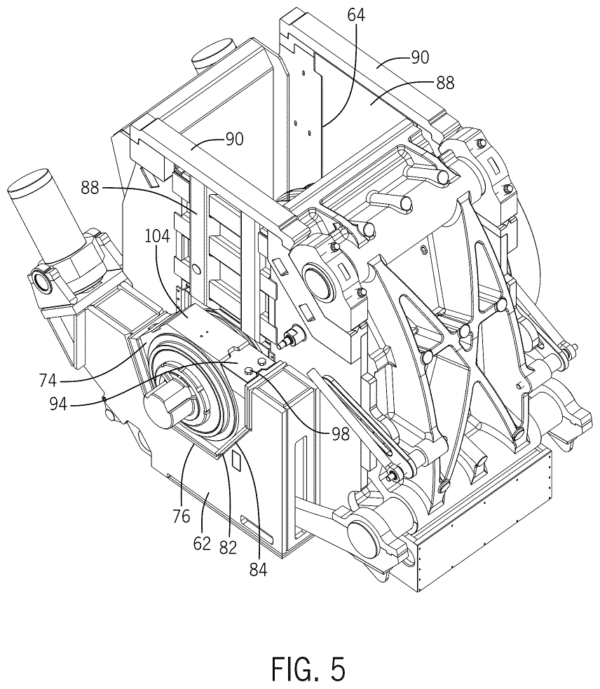

In the exploded view of FIG. 4, a pair of side wall panels 88 are shown in their removed condition. As can be understood in FIG. 5, when each of the side wall panels 88 are installed in the operating position, the side wall panels 88 block off the receiving channel 64. Each of the side wall panels 88 is positioned inward from the bearing assembly to combine with the side wall 40 to define the outer walls of the crushing chamber. Each of the side wall panels 88 are retained at the upper end by a locking rail 90. The locking rail 90 engages portions of the frame to lock the pair of side wall panels 88 in their assembled condition, as shown in FIG. 5. However, when the crushing roller assembly 72 is to be removed for servicing or repairs, the locking rails 90 are removed and the side wall panels 88 lifted away from the frame to unblock the receiving channels 64. Once unblocked, the crushing roller assembly 72 can be moved vertically within the open receiving channel 64. The removal of the side wall panels 88 and locking rails 90 create access for the insertion and removal of the crushing roller assembly 72.

FIG. 5 illustrates the installed position of the entire crushing roller assembly 72. In this installed position, the bearing assembly 74 is securely retained and held within the bearing cradle 76 formed as part of the bearing support structure 62. When the crushing roller assembly 72 is in the installed position, a locking assembly of the present disclosure holds the pair of bearing assemblies 74 within the bearing cradle 76 to prevent both vertical and axial movement of the bearing assemblies 74.

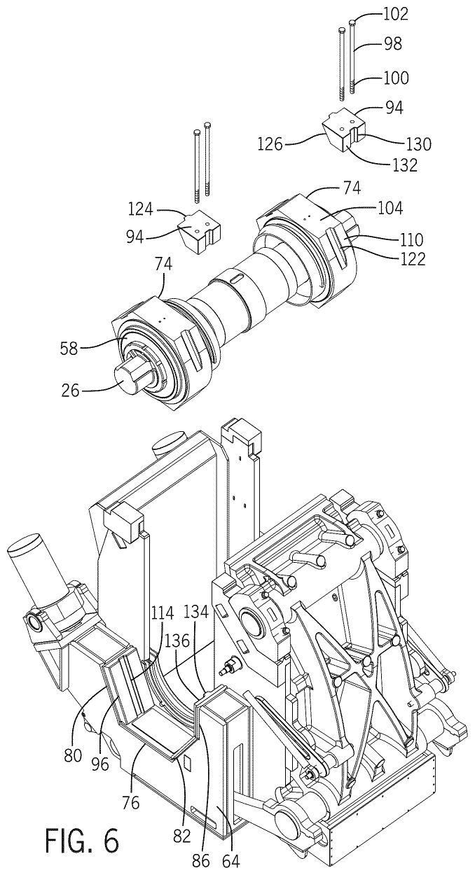

Referring now to FIG. 6, the locking assembly used to hold the bearing assembly 74 within the bearing cradle 76 includes a locking wedge 94 and a clamping wedge 96. Locking assemblies are included for each of the bearing cradles 76 to thus secure the bearing assembly 74 on each end of the drive shaft 26. Each of clamping wedges 96 is installed along the sloping front wall 80 that defines a portion of the bearing cradle 76. The pair of locking wedges 94 are each removably installed within the bearing cradle 76 through a sliding interaction with the vertical portion 86 of the back wall 82. The locking wedges 94 are each secured and retained by a pair of locking bolts 98 that each have a threaded lower end 100 and a head 102. The locking bolts 98 extend into and are received within internally threaded bores (not shown) formed in the bearing support structure 62.

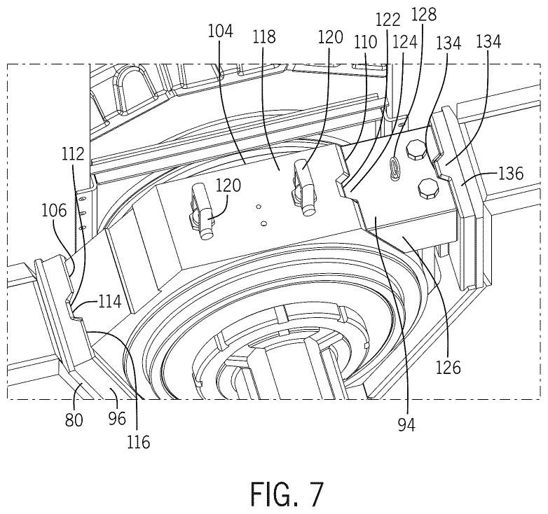

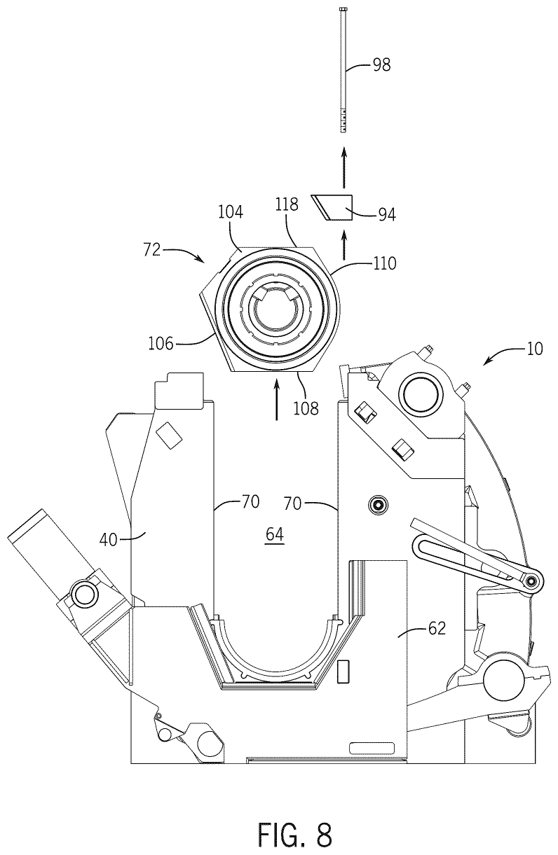

As can be seen in FIGS. 6 and 7, each of the bearing assemblies 74 includes an outer housing 104 that is sized to receive and retain the eccentric bearing 58 and the drive shaft 26. As shown in FIG. 8, the outer housing 104 includes a generally straight lower engagement wall 106, a flat bottom support surface 108 and an upper locking surface 110. Referring now to FIG. 7, the engagement wall 106 in the embodiment illustrated includes a protruding locking ridge 112 that is designed to be received within a locking channel 114 formed in an outer surface 116 of the clamping wedge 96 that is installed along the front wall 80. The interaction between the locking ridge 112 and the locking channel 114 prevents the axial movement of the bearing outer housing 104 during operation of the compact eccentric crusher. In the embodiment shown, top wall 118 of the outer housing 104 can include a pair of lifting lugs 120 that provide a point of attachment for lifting the entire crushing roller assembly during both installation and removal of the crushing roller assembly. The lifting lugs 120 can either be left in place during operation or removed during operation and installed when the crushing roller assembly is to be removed from the eccentric roller crusher.

As shown in FIG. 7, the upper locking surface 110 of the outer housing 104 includes a locking channel 122 that is sized to receive a locking ridge 124 that extends from a sloping contact surface 126 formed as part of the locking wedge 94. The configuration of the locking channel 122 and the locking ridge 124 can further be seen in the exploded view of FIG. 6. As shown in FIG. 6, the locking channel 122 extends over a length of the locking surface 110 that is longer than the length of the sloping contact surface 126 of the locking wedge 94. In this manner, the locking wedge 94 can move along the entire length of the locking channel 122. The length of the locking channel 122 is greater than the length of the sloping contact surface 126. As illustrated, the top surface of the locking wedge 94 can further include a lifting lug 128 that can be used to lift and lower the locking wedge 94. As with the lifting lugs 120, the lifting lug 128 can either remain in place during operation or can be removed and re-installed when the locking wedge 94 is to be removed.

As shown in FIGS. 6 and 7, the locking wedge 94 includes a locking channel 130 formed in the back wall 132 of the locking wedge 94. The locking channel 130 is sized to receive a locking ridge 134 that protrudes from a plate 136 mounted to the vertical wall portion 86. The interaction between the locking channel 130 and the locking ridge 134 further aids in preventing any axial movement of the locking wedge 94.

Referring back to FIG. 5, as previously described, the locking wedge 94 is held in position by the pair of locking bolts 98 that each extend through the sloping portion 84 of the back wall 82 and are received within internal, threaded bores formed in the bearing support structure 62 (not shown). The pair of locking bolts 98 thus prevent the vertical movement of the locking wedges 94 while the interaction between the mating channels and ridges prevent the axial movement of the outer housing 104.

Although certain configurations and locations of the locking channels and locking ridges are shown with respect to both the clamping wedge 96 and the locking wedge 94, it should be understood that the orientation and location of the locking channels and locking ridges could be reversed while operating within the scope of the present disclosure. As an illustrative example, the locking channel 114 could be replaced with a locking ridge and the locking ridge 112 replaced with a locking channel. The interaction between the respective locking channels and locking ridges is designed to both aid in alignment during the installation and to prevent any axial movement of the outer housing 104 of the bearing assemblies during operation of the compact eccentric crusher of the present disclosure.

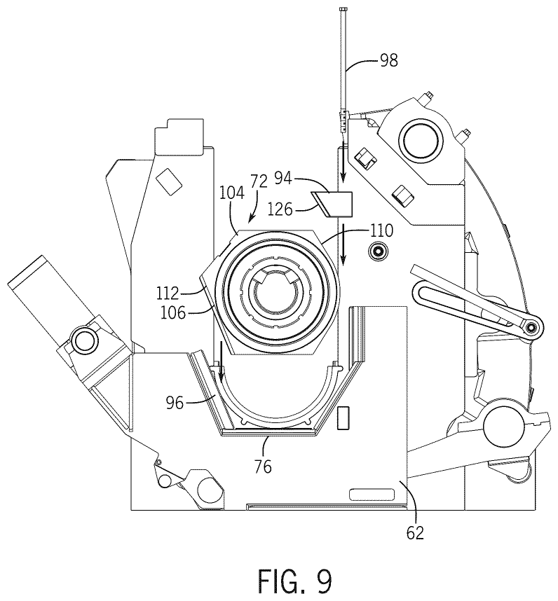

FIGS. 8 and 9 illustrate the removal and installation of the crushing roller assembly 72 in accordance with the present disclosure. Once the crushing roller assembly 72 is in the installed condition shown in FIG. 2, if the crushing roller assembly 72 needs to be removed for maintenance or other reasons, the initial step in the removal process is the removal of the locking rail 90 and the associated side wall panels 88. Once these components are removed, the receiving channel 64 is vertically open between the pair of spaced side edges 70 defined by the side wall 40. Once the receiving channel 64 is opened, the retaining bolts 98 of the locking assembly are rotated and removed from their threaded interaction with bores formed in the bearing support structure 62. Once the locking bolts 98 have been removed, the locking wedges 94 can be lifted vertically to thereby release the outer housing 104. As stated previously, the lifting lug 128 shown in FIG. 7 can be used to lift the locking wedge 94 away from contact with the outer housing 104. Since the outer housing 104 is located axially outward from the side walls 40, a crane or other lifting assembly can be used to engage the lifting lugs 120 to lift the entire crushing roller assembly 72 vertically as illustrated in FIG. 8. Once the entire crushing roller assembly 72 has been removed, the crushing roller assembly 72 can be moved to a maintenance location, placed on a truck or otherwise moved away from the compact eccentric crusher 10.

Once the maintenance has been carried out as needed, the crushing roller assembly 72 can be reinserted into the eccentric roller crusher as shown in FIG. 9. Initially, the crushing roller assembly 72 is lowered until the outer housing 104 contacts the bearing cradle 76 formed as part of the bearing support structure 62. As described previously and as is shown in FIG. 6, the front wall 80 includes the clamping wedge 96 which includes a locking channel 114. The locking channel 114 is designed to receive and engage the locking ridge 112 formed on the engagement wall 106 of the outer housing 104. The interaction between the locking channel 114 on the clamping wedge 96 and the locking ridge 112 formed on the outer housing 104 helps to guide the insertion of the outer housing 104 as shown in FIG. 9.

Once the outer housing 104 is resting within the bearing cradle 76, the locking wedge 94 is installed as illustrated. As shown in FIG. 5, when the locking wedge 94 is in place, the pair of locking bolts 98 can be installed and tightened. During tightening of the locking bolts 98, the angled contact surface 126 engages a similar angled locking surface 110 formed on the outer housing 104. The downward clamping force created by the locking bolts 98 creates a downward and outward force which presses the engagement wall 106 of the outer housing 104 into contact with the clamping wedge 96. The downward force created by the rotation of the locking bolts 98 creates both a downward and outward force creating physical interaction between the clamping wedge 96 and the engagement wall 106 of the outer housing 104. In this manner, the locking assembly, which includes the combination of the locking wedge 94 and the clamping wedge 96, can be used to secure the entire crushing roller assembly 72 within the bearing support structure 62. The locking assembly of the present disclosure allows the quick and easy release of the crushing roller assembly such that the crushing roller assembly can be removed from the compact eccentric crusher 10.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A crusher for crushing a supply of mineral material, the crusher comprising:
a crusher frame having a pair of side walls that at least partially define a crushing chamber;
a stationary crushing member;
a crushing roller spaced from the stationary crushing member by a crushing gap, wherein the crushing roller is movable toward and away from the stationary crushing member to change the crushing gap and crush the mineral material within the crushing gap;
a drive shaft supporting the crushing roller;
a pair of bearing assemblies coupled to the drive shaft to rotatably support a first end and a second end of the drive shaft;
a pair of bearing support structures each positioned adjacent to one of the side walls of the crusher frame, the bearing support structures each including a bearing cradle configured to support one of the bearing assemblies; and
a locking assembly positioned between the bearing support structure and the bearing assembly to retain the bearing assembly in the bearing cradle in an installed position and to allow removal of the bearing assembly from the bearing cradle in a removed position.

2. The crusher of claim 1 wherein each of the bearing cradles includes an open upper end configured such that the pair of bearing assemblies can be vertically inserted into the bearing cradles and vertically removed from the bearing cradles.

3. The crusher of claim 2 wherein each of the bearing cradles includes a bottom wall and a sloping front wall, wherein the locking assembly includes a clamping wedge mounted to the sloping front wall that engages one of the bearing assemblies to restrict axial movement of the bearing assembly when the bearing assembly is received in the bearing cradle.

4. The crusher of claim 3 wherein the clamping wedge includes a locking groove that receives a locking ridge formed on one of the bearing support structures.

5. The crusher of claim 3 wherein the locking assembly further includes a locking wedge removably secured to the bearing support structure to retain the bearing assembly in the bearing cradle.

6. The crusher of claim 5 wherein the bearing cradle includes a back wall having a second locking ridge that is received in a locking groove formed the locking wedge and the locking wedge includes a third locking ridge that is received in a second locking groove formed in an outer housing of the bearing assembly.

7. The crusher of claim 4 wherein the clamping wedge includes a sloping contact surface that engages a sloping engagement surface formed on an outer housing of the bearing assembly, wherein vertical movement of the clamping wedge into contact with the sloping engagement surface of the outer housing of the bearing assembly urges the bearing assembly rearward and downward into contact with the clamping wedge.

8. The crusher of claim 1 further comprising at least one eccentric bearing to create eccentric movement of the crushing roller upon rotation of the drive shaft.

9. A compact eccentric crusher comprising:
a crusher frame having a pair of side walls that at least partially define a crushing chamber;
a crusher jaw;
a crushing roller spaced from the stationary crusher jaw by a crushing gap, wherein the crushing roller is movable toward and away from the crusher jaw to change the crushing gap and crush the mineral material within the crushing gap;
a drive shaft supporting the crushing roller;
a pair of bearing assemblies positioned to rotatably support a first end and a second end of the drive shaft, wherein each of the bearing assemblies includes an outer ;
a pair of bearing support structures each positioned adjacent to one of the side walls of the crusher frame, the bearing support structures each including a bearing cradle configured to receive and support the outer housing of one of the bearing assemblies; and
a locking assembly positioned between the bearing support structure and the outer housing of the bearing assembly to retain the bearing assembly in the bearing cradle in an installed position and to allow removal of the bearing assembly from the bearing cradle in a removed position.

10. The compact eccentric crusher of claim 9 wherein each of the bearing cradles includes an open upper end aligned with a receiving channel formed in each of the side walls of the frame such that the pair of bearing assemblies can be vertically inserted into the bearing cradles and vertically removed from the bearing cradles through the receiving channels.

11. The compact eccentric crusher of claim 10 further comprising a side wall panel positioned above the bearing assembly to block the receiving channel when the bearing assembly is in the installed position.

12. The compact eccentric crusher of claim 10 wherein each of the bearing cradles includes a bottom wall, a sloping front wall and a back wall, wherein the locking assembly includes a clamping wedge mounted to the sloping front wall and a locking wedge that is received between the outer housing of one of the bearing assemblies and the back wall.

13. The compact eccentric crusher of claim 12 wherein the locking assembly restricts axial movement and vertical movement of the outer housing of the bearing assembly when the bearing assembly is received in the bearing cradle.

14. The compact eccentric crusher of claim 12 wherein the clamping wedge and the outer housing of the bearing assembly include a mating locking channel and locking ridge.

15. The compact eccentric crusher of claim 14 wherein the back wall of the bearing cradle includes a second locking ridge that is received in a locking groove formed in the locking wedge and the locking wedge includes a third locking ridge that is received in a second locking groove formed in the outer housing of one of the bearing support structures.

16. The compact eccentric crusher of claim 12 wherein the clamping wedge includes a sloping contact surface that engages a sloping engagement surface formed on the outer housing of the bearing assembly, wherein vertical movement of the clamping wedge into contact with the engagement surface of the outer housing urges the outer housing rearward and downward into contact with the clamping wedge.

17. A method of removably mounting a crushing roller assembly into a compact eccentric crusher having a frame and a pair of bearing support structures positioned adjacent to side walls of the frame and each including a bearing cradle, the method comprising the steps of:
lowering the crushing roller assembly until an outer housing of the crushing roller assembly is received in one of the bearing cradles;
positioning a locking wedge between a locking surface on the outer housing and the bearing cradle;
exerting a locking force on the locking wedge to force the outer housing into contact with a clamping wedge positioned in the bearing cradle; and
retaining the locking wedge in position to restrict axial movement and vertical movement of the outer housing.

18. The method of claim 17 wherein the outer housing supports one end of a drive shaft of the crushing roller assembly.

19. The method of claim 17 further comprising the steps of:
removing the locking force from the locking wedge;
removing the locking wedge from contact with the outer housing; and
lifting the crushing roller assembly from contact with the bearing cradles.

20. The method of claim 17 wherein the outer housing includes one of a locking ridge or a locking channel that is received within the other of a locking channel and a locking ridge formed in the clamping wedge such that the interaction between the locking ridge and the locking channel restrict axial movement of the outer housing.
